(19) United States
(12) Patent Application Publication
(10) Pub. No.: US 2009/0011290 A1
(43) Pub. Date: Jan. 8, 2009

(54) Method and apparatus for thermochemical recuperation with partial heat recovery of the sensible heat present in products of combustion

(75) Inventors: Yaroslav Chudnovsky, Snokie, IL (US); Aleksandr Kozlov, Buffalo Grove, IL (US); David Rue, Chicago, IL (US); Mark J. Khinkis, Morton Grove, IL (US); Vilyam G. Nosach, Kiev (UA); Harry S. Kurek, Dyer, IN (US)

Correspondence Address: MARK E. FEJER;GAS TECHNOLOGY INSTITUTE, 1700 SOUTH MOUNT PROSPECT ROAD, DES PLAINES, IL, 60018, US

(73) Assignee: GAS TECHNOLOGY INSTITUTE, Des Plaines, IL (US)

(21) Appl. No.: 11/825,230

(22) Filed: Jul. 5, 2007

(51) Int. Cl. H01M 8/18; H01M 8/04

(52) U.S. Cl. 429/17; 429/20

(57) ABSTRACT

A system and method for fuel reforming in which at least a portion of the exhaust gases from a combustion process, such as an industrial furnace, is mixed with a fuel, such as natural gas, and the mixture is introduced into a first stage heat exchange vessel in which the fuel is reformed. The reformed fuel is then returned to the combustion process for burning. In accordance with one embodiment, primary combustion oxidant is introduced into a second stage heat exchange vessel in which it is heated by a portion of the exhaust gas exiting the first stage heat exchange vessel. The heated oxidant is then introduced into the combustion process for burning of the fuel(s) therein.

### BACKGROUND OF THE INVENTION

1. Field of the Invention

This invention relates to heat and thermal chemical processes, in particular, recuperation systems of gas-fired devices. More particularly, this invention relates to thermochemical recuperators and the use of thermochemical recuperators as fuel reformers for providing reformed fuel to a combustion process.

2. Description of Related Art

Natural gas is the most abundant energy source available after coal. Because it is inexpensive and burns very cleanly relative to other energy sources, particularly with respect to coal, more ways are continually being investigated for using natural gas as a fuel. In addition, because natural gas is in abundant supply, using more natural gas as an energy source provides a means for reducing dependence on imported foreign oils.

Over the past several years, fuel cells, which typically use hydrogen (H₂) as a fuel, have been receiving a substantial amount of attention due to their almost emission-free operation. The primary exhaust from a fuel cell using hydrogen, as with other systems in which hydrogen is used as a fuel, is water. It will, thus, be apparent that substantial environmental benefits may be realized from the use of hydrogen as a fuel in applications other than fuel cells, such as combustion processes in industrial furnaces and the like. However, one problem associated with the use of hydrogen in such applications is the requirement for ready availability of the hydrogen in a form suitable for use therein. Thus, one issue which needs to be addressed is the production of H₂ in a manner which satisfies the availability requirements.

Several reforming technologies to produce H₂ are known, including autothermal reforming, partial oxidation reforming, plasma reforming, and steam reforming. Reforming of natural gas or other hydrocarbons produces H₂-enriched products which, in addition to H₂, may also include CO, CO₂, and carbon. At the present time, about 90% of the hydrogen produced around the world is from reforming natural gas, as a result of which demand for natural gas is increasing considerably. Recently, efforts to develop various kinds of fuel reformers to reform liquid or gaseous fuels to produce H₂-enriched fuels have increased substantially. Most of these reformers use steam reforming technology, which requires heat and steam.

In a typical combustion process, a significant amount of energy is wasted. Thus, if this energy can be used to reform a lower quality fuel to produce a higher quality fuel, combustion efficiency will increase significantly.

### SUMMARY OF THE INVENTION

It is, thus, one object of this invention to provide a method and apparatus for increasing the efficiency of conventional combustion processes.

It is another object of this invention to provide a method and apparatus for decreasing the fuel consumption of conventional combustion processes.

It is another object of this invention to provide a method and apparatus for thermochemical recuperation reforming using exhaust gas from a combustion process as a thermochemical fuel conversion reactant.

These and other objects of this invention are addressed by a system for fuel reforming comprising at least one wall enclosing a combustion chamber having a primary fuel inlet, a primary oxidant inlet, and an exhaust gas outlet. Disposed downstream of the combustion chamber is a first stage heat exchange vessel having a first stage exhaust gas inlet in fluid communication with the exhaust gas outlet of the combustion chamber and having a first stage exhaust gas outlet. A reformer fuel conduit having a reformer fuel inlet in fluid communication with a reformer fuel supply and having a reformed fuel outlet in fluid communication with the combustion chamber is disposed within the first stage heat exchange vessel. To enable use of the exhaust gas as a reactant in the reforming process, the first stage exhaust gas outlet is in fluid communication with the reformer fuel inlet. In this manner, the exhaust gas from the combustion chamber is used to increase the enthalpy of the fuel and the combustion oxidant, e.g. air, and to increase the chemical energy of the fuel. The increased enthalpies and chemical energy of the fuel provide higher heat input to the combustion chamber, increase efficiency of the combustion process and decrease the fuel consumption by the combustion process.

In accordance with the method of this invention, the exhaust gas is used for chemical conversion (reforming) of a fuel (referred to herein as a “reformer fuel”) to a state of higher chemical energy and for combustion air preheat. In order to reform the reformer fuel, it is mixed at a certain ratio with the exhaust gas, after which the mixture is heated in a reformer to reform the fuel. As a result of the reforming process, the reformed fuel that is produced contains hydrogen and carbon monoxide which may be supplied to burners for combustion. The thermal reforming process is accompanied by absorption of a considerable amount of heat (endothermic process), thus recovering much more heat in comparison with conventional thermal-only recuperation that leads to a potential for a substantial increase in furnace productivity and improved product quality, a substantial increase in system thermal efficiency, reduction in specific consumption of fuel, and considerable reduction in pollutant emissions. The amount of the exhaust gas for reforming may be slightly higher, equal to, or less than theoretical values to provide the highest thermal process efficiency. A reformed fuel cooling device may be used to reduce the temperature of the fuel at the combustion chamber fuel inlet and/or partially remove moisture from the fuel.

### BRIEF DESCRIPTION OF THE DRAWINGS

These and other objects and features of this invention will be better understood from the following detailed description taken in conjunction with the drawings wherein:

FIG. 1 is a schematic diagram of a thermochemical recuperator (TCR) system employing exhaust gas/fuel recuperative reforming in accordance with one embodiment of this invention;

FIG. 2 is a schematic diagram of a thermochemical recuperator system employing exhaust gas/fuel reforming and utilizing a sorbent bed for exhaust gas cleanup in accordance with one embodiment of this invention;

FIG. 3 is a schematic diagram of a thermochemical recuperator system employing exhaust gas/fuel reforming at low exhaust gas temperatures in accordance with one embodiment of this invention;

FIG. 4 is a schematic diagram of turbulators in a heat exchange tube employed in accordance with one embodiment of the system of this invention;

FIG. 5 is a schematic top view of sheaths attached to thermochemical recuperator heat transfer tubes and/or thermal heat transfer tubes in accordance with one embodiment of this invention; and

FIG. 6 is a schematic top view of plates enclosing thermal recuperator tubes in accordance with one embodiment of this invention.

### DETAILED DESCRIPTION OF THE PRESENTLY PREFERRED EMBODIMENTS

As used herein, the term “combustion process” refers to the burning of a fuel in a combustion chamber, such as an industrial furnace, and explicitly excludes the combustion of a fuel in internal combustion engines, turbines, and the like.

This invention relates to thermochemical recuperation systems with exhaust (flue) gas/fuel reforming. The recuperative process is characterized by chemical reaction temperatures in the range of about 500° F. to about 1800° F. and can take place at a low absolute pressure (about 14.7 psig or lower) or high pressure (higher than 14.7 psig). Higher temperature is needed to achieve higher reforming rates of the fuel and higher efficiencies. Exhaust gas/fuel ratio depends upon the type of fuel used in the combustion process. For natural gas or methane (CH₄), the exhaust gas/methane optimal mole ratio is from about 1:100 to about 1:3 (⅓×{CO₂+2H₂O+7.52N₂}+CH₄) depending upon temperature and exhaust gas composition. The stoichiometric, theoretical exhaust gas mole composition is CO₂+2H₂O+7.52N₂. Reforming processes with lower methane ratios (<1:100) have an essential lack of oxidizers (H₂O and CO₂) in the reforming mixture; thus, reforming is not efficient. Reforming processes with higher ratios (>1:3) have an excess of essential oxidizers and are favorable for the reforming rate but less favorable with respect to efficiency. For natural gas or methane/steam reforming, the optimal steam/fuel ratio is from about 1:30 to about 2:1 (H₂O+CH₄).

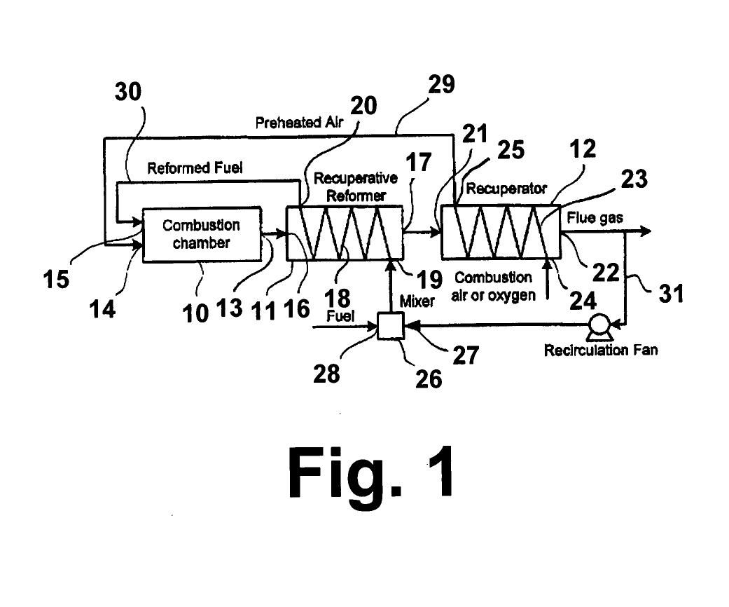

FIG. 1 is a schematic diagram of a thermochemical recuperator system employing exhaust gas/fuel recuperative reforming in accordance with one embodiment of this invention. As shown therein, the system comprises combustion chamber 10 having fuel inlet 15, oxidant inlet 14 and exhaust gas outlet 13, first stage heat exchange vessel 11 having first stage exhaust gas inlet 16 in fluid communication with exhaust gas outlet 13 of combustion chamber 10 and having first stage exhaust gas outlet 17, and second stage heat exchange vessel 12 having second stage exhaust gas inlet 21 in fluid communication with first stage exhaust gas outlet 17 and having second stage exhaust gas outlet 22. Reformer fuel conduit 18, having reformer fuel inlet 19 in fluid communication with a reformer fuel supply and reformed fuel outlet 20 in fluid communication with combustion chamber 10 by virtue of reformed fuel line 30, is disposed within first stage heat exchange vessel 11 in heat exchange relationship with exhaust gas entering first stage heat exchange vessel 11 through first stage exhaust gas inlet 16. As used herein, the term “conduit” refers to any defined fluid flow path whereby the fluid flowing along the flow path is physically isolated from fluids disposed around the flow path, i.e. no mixing of the fluids. In the instant case, the reformer fuel flowing through the reformer fuel conduit is physically separated from the exhaust gas flowing through the heat exchanger. Such conduits may be formed as tubes such as in a shell and tube-type heat exchanger or formed by plates such as in plate-type heat exchangers. Second stage exhaust gas outlet 22 is in fluid communication with the reformer fuel supply by means of exhaust gas return line 31 whereby the exhaust gas is mixed with the reformer fuel prior to being introduced into the reformer fuel conduit.

In accordance with one embodiment of this invention, at least one of the heat exchange vessels employed in the system of this invention is provided with heat transfer means for promoting or enhancing the transfer of heat between the exhaust gases entering the heat exchange vessels and the materials and fluids disposed within the fuel reformer conduits. Such heat transfer enhancements include, but are not limited to, extended heat transfer surfaces such as fins and studs connected with the fuel reformer conduits, vortex generators such as dimples and winglets formed by the inner and/or outer surfaces of the fuel reformer conduits, and fluidized bed and porous matrix techniques.

Mixing of the reformer fuel and the exhaust gas is accomplished by mixer 26 having mixer exhaust gas inlet 27, which is in fluid communication with second stage exhaust gas outlet 22, and having mixer reformer fuel inlet 28, which is in fluid communication with the reformer fuel supply. By virtue of this arrangement, exhaust gas exiting first stage heat exchange vessel 11 through first stage exhaust gas outlet 17 is lower in temperature than the exhaust gas entering first stage heat exchange vessel 11 through first stage exhaust gas inlet 16 and reformer fuel flowing through reformer fuel conduit 18 is reformed.

Disposed within second stage heat exchange vessel 12 in heat exchange relationship with exhaust gas flowing there through is oxidant conduit 23 having oxidant inlet 24 in fluid communication with an oxidant source and having oxidant outlet 25 in fluid communication with combustion chamber 10 by virtue of preheated oxidant line 29. By virtue of this arrangement, exhaust gas flowing through second stage heat exchange vessel 12 heats the oxidant flowing through the oxidant conduit, and the exhaust gas exiting from the second stage heat exchange vessel is lower in temperature than the exhaust gas entering the vessel.

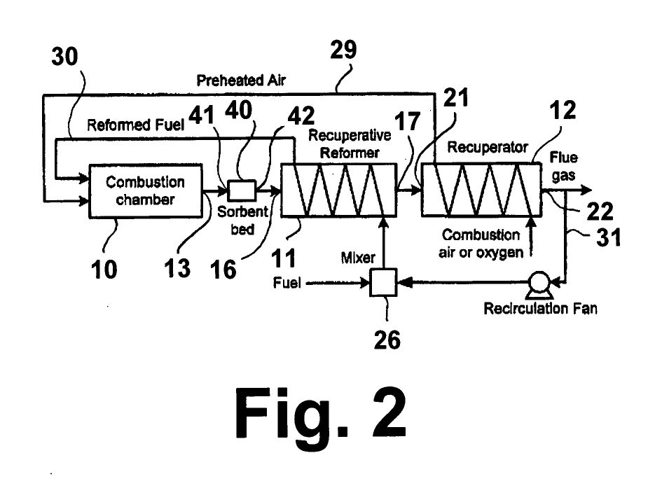

Exhaust gases from combustion processes may be chemically aggressive and cause reformer corrosion. In such cases, it is desirable to clean or chemically treat the exhaust gases prior to being introduced into the reformer. A sorbent bed may be used to prevent or reduce chemically aggressive contaminants in the exhaust gases. Accordingly, in accordance with one embodiment of this invention as shown in FIG. 2, sorbent bed 40 having sorbent bed exhaust gas inlet 41 in fluid communication with exhaust gas outlet 13 of combustion chamber 10 and having sorbent bed exhaust gas outlet 42 in fluid communication with first stage exhaust gas inlet 16 is provided. Several sorbents may be used which are either single use materials or materials that can be removed and regenerated for reuse in the sorbent bed. The sorbent bed is intended for the removal of low-concentration exhaust gas species that are corrosive to heat exchanger and reformer surfaces. These corrosive species include halogens (primarily chlorine and fluorine), alkalis, ammonia, boron species, and sulfur species. Preferably, the sorbent bed should be operated at the temperature of the exhaust gas, typically in the range of about 800° F. to about 1800° F., to avoid heat losses that could lead to decreased efficiency. Although removal of corrosive exhaust gas constituents at high temperatures is generally more costly than commonly practiced methods, the sorbent bed, when used in combination with TCR or even thermal recuperation alone, provides longer equipment service life while eliminating the need for lower-temperature corrosive component removal processes. In addition, the sorbent bed protects the burner and combustion system from corrosion by removing corrosive components from the exhaust gas before the exhaust gas is blended or mixed with the reformer fuel entering the reformer fuel conduit.

An alternative means for protecting the TCR surfaces against corrosion is to fabricate all surfaces from materials that are chemically inert in the presence of the exhaust gas. These materials include, but are not limited to, a range of steel alloys, ceramics, intermetallics (such as silicon carbide), and composites made by putting a permanent or sacrificial coating on the TCR surfaces.

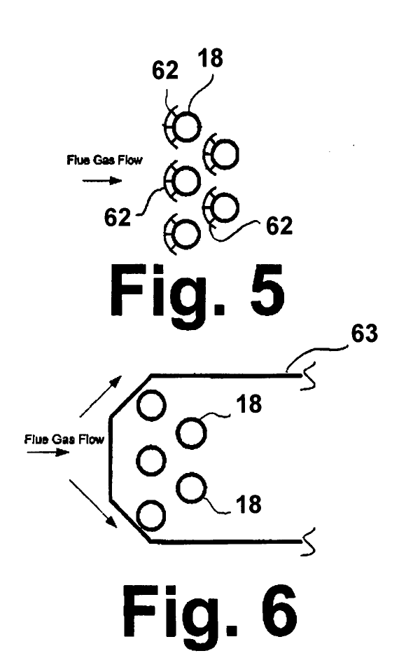

Others means for protecting the TCR surface against corrosion are shown in FIGS. 5 and 6. In accordance with one embodiment of this invention as shown in FIG. 5, at least one expendable arcuate (180°-270°) silicon-silicon carbide sheath 62 may be tack-cemented to the leading surface of the heat transfer surfaces of at least a portion of the conduits disposed within the heat exchange vessels to physically shield the tubes from coming in contact with the corrosive species. In accordance with another embodiment of this invention as shown in FIG. 6, an expendable silicon-silicon carbide enclosure constructed of a plurality of silicon-silicon carbide plates 63 is used to enclose the heat transfer surfaces of the conduits, thereby substantially eliminating contact of the conduits by the corrosive species in the exhaust gas while allowing heat to be transferred by convection from the exhaust gas to the enclosure which, in turn, transfers heat by radiation to the conduits.

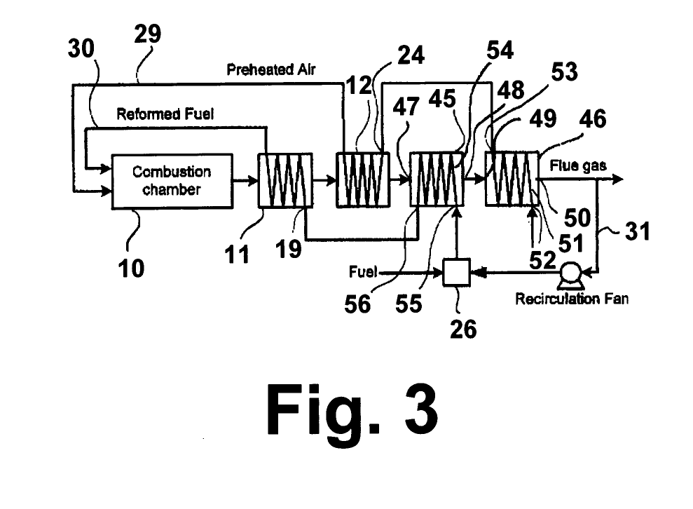

In accordance with one embodiment of this invention, which embodiment is particularly suitable for use with relatively low temperature exhaust gases, i.e. temperatures less than about 800° F., the system comprises an additional two stages of exhaust gas heat exchange as shown in FIG. 3. In particular, in addition to the first and second heat exchange vessels 11 and 12, respectively, the system comprises third stage heat exchange vessel 45 having third stage exhaust gas inlet 47 in fluid communication with second stage exhaust gas outlet 22 and having third stage exhaust gas outlet 48, and fourth stage heat exchange vessel 46 having fourth stage exhaust gas inlet 49 in fluid communication with third stage exhaust gas outlet 48 and having fourth stage exhaust gas outlet 50 in fluid communication with the reformer fuel source. Disposed within third stage heat exchange vessel 45 is third stage reformer fuel conduit 54 having third stage reformer fuel inlet 55 in fluid communication with mixer 26 and having third stage reformer fuel outlet 56 in fluid communication with reformer fuel inlet 19. Disposed within fourth stage heat exchange vessel 46 is fourth stage oxidant conduit 51 having fourth stage oxidant conduit inlet 52 in fluid communication with the oxidant source and having fourth stage oxidant conduit outlet 53 in fluid communication with oxidant conduit inlet 24.

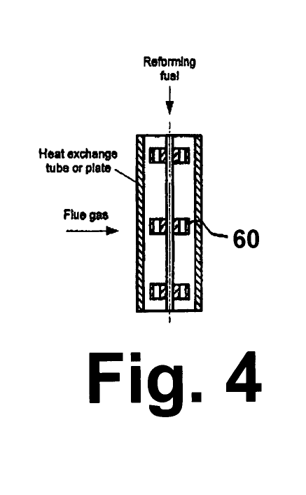

One of the key requirements of the thermochemical reforming process of this invention is the necessity of effectively utilizing the supply of heat into the chemical reaction zone per unit of time. Because the reaction is endothermic and proceeds only with the addition and effective use of external heat (such as from hot exhaust gas) per unit of time, heat transfer enhancements in accordance with one preferred embodiment of this invention are provided to optimize the transfer of the external heat to the reforming process. As shown in FIG. 4, turbulators 60, which may consist of small baffles, angular metal strips, spiral blades, or coiled wire, are disposed within at least a portion of the reformer fuel conduit to break up the laminar boundary layer, thereby intensifying heat transfer and increasing the fuel reforming rate. It will be appreciated by those skilled in the art that any physical structure that provides high flow turbulence and intensive mixing in the conduit and that does not contribute significantly to pressure drop is acceptable. Such turbulators may be installed inside the conduit (tube) of a shell and tube-type heat exchanger or between flat plates of a plate-type heat exchanger.

A method for thermochemical recuperation in accordance with one embodiment of this invention comprises introducing a heated exhaust gas from a combustion chamber into a first stage heat exchange vessel, producing a cooler exhaust gas, followed by introducing the cooler exhaust gas into a second stage heat exchange vessel, producing a further cooled exhaust gas. As the exhaust gas flows through the first heat exchange vessel, the further cooled exhaust gas is mixed with a reformer fuel, such as natural gas, to form a fuel/exhaust gas mixture, which mixture is then introduced into at least one reformer conduit disposed within the first stage heat exchange vessel in heat exchange relationship with the heated exhaust gas, resulting in the production of a reformed fuel. A primary combustion oxidant, i.e. air, oxygen-enriched air or oxygen, is introduced into at least one oxidant conduit disposed in the second stage heat exchange vessel in heat exchange relationship with cooler exhaust gas, producing heated primary combustion oxidant, which is then introduced together with the reformed fuel into the combustion chamber in which the reformed fuel is combusted. In accordance with one embodiment of this invention, the fuel/exhaust gas mixture is preheated prior to being introduced into the at least one reformer conduit. In accordance with one embodiment of this invention, the primary combustion oxidant is preheated prior to being introduced into the at least one oxidant conduit. In accordance with yet another embodiment of this invention, the heated exhausted gas is passed through a sorbent bed for removal of the corrosive contaminants prior to being introduced into the first stage heat exchange vessel.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. A system for fuel reforming comprising:
at least one wall enclosing a combustion chamber having a primary fuel inlet, a primary oxidant inlet, and an exhaust gas outlet;
a first stage heat exchange vessel having a first stage exhaust gas inlet in fluid communication with said exhaust gas outlet and having a first stage exhaust gas outlet;
at least one reformer fuel conduit disposed within said first stage heat exchange vessel having a reformer fuel inlet in fluid communication with a reformer fuel supply and having a reformed fuel outlet in fluid communication with said combustion chamber; and
said first stage exhaust gas outlet in fluid communication with said reformer fuel inlet.

2. A system in accordance with claim 1 further comprising a second stage heat exchange vessel having a second stage exhaust gas inlet in fluid communication with said first stage exhaust gas outlet and having a second stage exhaust gas outlet in fluid communication with said reformer fuel inlet, and at least one oxidant conduit disposed within said second stage heat exchange vessel having an oxidant inlet in fluid communication with an oxidant supply and having an oxidant outlet in fluid communication with said primary oxidant inlet.

3. A system in accordance with claim 1 further comprising a fluid mixer having a mixer exhaust gas inlet in fluid communication with said second stage exhaust gas outlet, a mixer fuel inlet in fluid communication with said reformer fuel supply, and a mixer outlet in fluid communication with said reformer fuel inlet.

4. A system in accordance with claim 1 further comprising a sorbent bed having a sorbent bed inlet in fluid communication with said exhaust gas outlet and having a sorbent bed outlet in fluid communication with said first stage exhaust gas inlet.

5. A system in accordance with claim 2 further comprising a third stage heat exchange vessel having a third stage exhaust gas inlet in fluid communication with said second stage exhaust gas outlet and having a third stage exhaust gas outlet, at least one third stage reformer fuel conduit disposed within said third stage heat exchange vessel having a third stage reformer fuel inlet in fluid communication with said reformer fuel supply and having a third stage reformer fuel outlet in fluid communication with said reformer fuel inlet, a fourth stage heat exchange vessel having a fourth stage exhaust gas inlet in fluid communication with said third stage exhaust gas outlet and having a fourth stage exhaust gas outlet in fluid communication with said third stage reformer fuel inlet, and a fourth stage oxidant conduit disposed within said fourth stage heat exchange vessel having at least one fourth stage oxidant inlet in fluid communication with said oxidant supply and having a fourth stage oxidant outlet in fluid communication with said oxidant inlet.

6. A system in accordance with claim 5 further comprising a fluid mixer having a mixer exhaust gas inlet in fluid communication with said fourth stage exhaust gas outlet, a mixer fuel inlet in fluid communication with said reformer fuel supply, and a mixer outlet in fluid communication with said reformer fuel inlet.

7. A method for thermochemical recuperation comprising:
introducing a heated exhaust gas from a combustion chamber into a first stage heat exchange vessel, producing a cooler exhaust gas;
introducing said cooler exhaust gas into a second stage heat exchange vessel, producing a further cooled exhaust gas;
mixing said further cooled exhaust gas with a reformer fuel, forming a fuel/exhaust gas mixture;
introducing said fuel/exhaust gas mixture into at least one reformer conduit disposed within said first stage heat exchange vessel in heat exchange relationship with said heated exhaust gas, producing a reformed fuel;
introducing a primary combustion oxidant into at least one oxidant conduit disposed in said second stage heat exchange vessel in heat exchange relationship with said cooler exhaust gas, producing heated primary combustion oxidant; and
introducing said reformed fuel and said heated primary combustion oxidant into said combustion chamber, and combusting said reformed fuel in said combustion chamber.

8. A method in accordance with claim 7, wherein said fuel/exhaust gas mixture is preheated prior to being introduced into said at least one reformer conduit.

9. A method in accordance with claim 7, wherein said primary combustion oxidant is preheated prior to being introduced into said at least one oxidant conduit.

10. A method in accordance with claim 7, wherein said heated exhaust gas is treated for removal of corrosive contaminants present in said heated exhaust gas before being introduced into said first stage heat exchange vessel.

11. A method in accordance with claim 10, wherein said heated exhausted gas is passed through a sorbent bed for removal of said corrosive contaminants.

12. A method in accordance with claim 10, wherein said corrosive contaminants are selected from the group consisting of halogens, alkalis, ammonia, boron species, sulfur species, and combinations thereof.

13. A method in accordance with claim 7, wherein said reformer fuel is natural gas.
